(19) United States
(12) Patent Application Publication
(10) Pub. No.: US 2025/0153849 A1
(43) Pub. Date: May 15, 2025

(54) TRASH COMPACTION SYSTEMS AND METHODS

(71) Applicant: THE BOEING COMPANY, Arlington, VA (US)

(72) Inventors: Darren Carl McIntosh, Mukilteo, WA (US); Christopher B. Singleton, Bothell, WA (US)

(73) Assignee: THE BOEING COMPANY, Arlington, VA (US)

(21) Appl. No.: 18/678,071

(22) Filed: May 30, 2024

Related U.S. Application Data
(60) Provisional application No. 63/597,731, filed on Nov. 10, 2023.

(51) Int. Cl. B64D 11/02; B65F 1/14

(52) U.S. Cl. CPC B64D 11/02; B65F 1/14

(57) ABSTRACT

A system and method include a trash container configured to retain trash within an internal chamber. A sink is configured to retain water. The sink includes a drain configured to allow the water to pass out of the sink. A water outlet is disposed proximate to a top of the internal chamber of the trash container. One or more conduits fluidly connect the drain to the water outlet. The water outlet is configured to receive the water that passes out of the sink via the one or more conduits. The water saturates and compacts the trash within the internal chamber.

### CROSS-REFERENCE TO RELATED APPLICATIONS

This application relates to and claims priority benefits from U.S. Provisional Patent Application No. 63/597,731, filed Nov. 10, 2023, which is hereby incorporated by reference in its entirety.

### FIELD OF THE DISCLOSURE

Examples of the present disclosure generally relate to trash compaction system and methods, such as can be used within a lavatory, galley, or the like of an internal cabin of a commercial aircraft.

### BACKGROUND OF THE DISCLOSURE

Commercial aircraft are used to transport passengers between various locations. A typical commercial aircraft includes one or more lavatories within an internal cabin.

A lavatory within an internal cabin includes a toilet, a sink, and a trash container. Used paper towels, facial tissues, and the like may be disposed within the trash container.

A typical trash container within a lavatory of a commercial aircraft has a limited volume. In particular, the volume of a known trash container used within an aircraft lavatory has a volume of approximately one cubic foot. As can be appreciated, during a flight, the trash container may be quickly filled. Indeed, during particularly long flights, the trash container may fill to the point of overflowing, thereby requiring flight staff to empty the contents of the trash container into another holding container, trash bags, and/or the like.

An aircraft may include a powered compactor within a galley. The compactor typically includes a motor that is used to effect compaction. However, such a compactor is large and heavy, and is used to compact relatively dense trash, including beverage cans, food containers, and/or the like. Typical compactors within a galley of an aircraft are generally too large to fit within the confined space of a lavatory.

In general, the lavatories onboard commercial aircraft do not include any trash compactor. As such, flight staff sometimes manually compact trash with their hands (for example, by pushing down on the trash with their hands) in order to provide a trash container with increased capacity to accept trash. Unfortunately, such action can only be performed when the lavatory is unoccupied, and such action interrupts lavatory usage. Additionally, this approach does not offer a consistent and efficient way to increase waste volume in the waste compartments, and can be unhygienic.

U.S. Pat. No. 10,351,337 discloses a manually operated trash compactor for an airplane lavatory. U.S. Pat. No. 10,875,707 discloses trash compactor systems and methods. U.S. Pat. No. 11,577,909 discloses systems and methods for deployment of a compacting head in a waste compartment.

### SUMMARY OF THE DISCLOSURE

A need exists for a system and method for effectively and efficiently compacting trash within a trash receptable, such as within a lavatory of a commercial aircraft.

With that need in mind, certain examples of the present disclosure provide a system including a trash container configured to retain trash within an internal chamber. A sink is configured to retain water. The sink includes a first drain configured to allow the water to pass out of the sink. A water outlet is disposed proximate to a top of the internal chamber of the trash container. One or more conduits fluidly connect the first drain to the water outlet. The water outlet is configured to receive the water that passes out of the sink via the one or more conduits. The water is absorbed by the waste contents, thereby compacting the trash within the internal chamber.

In at least one example, a reservoir fluidly connects the water outlet and the one or more conduits. The reservoir is configured to receive a portion of the water that passes out of the sink.

In at least one example, the trash container includes a cover configured to be moved between an open position and a closed position. A linkage operatively couples the cover to one or both of the water outlet or the reservoir. Movement of the cover into the open position is configured to allow the water to pass out of the water outlet.

In at least one example, the trash container includes a second drain. The second drain is configured to allow the water to pass therethrough.

The trash container can also include a valve proximate to the second drain. The valve can be a float valve.

In at least one example, the water outlet includes one or more spray nozzles.

Certain examples of the present disclosure provide a method including compacting the trash within the internal chamber of the trash container by absorbing the water that passes out of the water outlet, and soaking and saturating the contents.

Certain examples of the present disclosure provide a vehicle including an internal cabin, a lavatory within the internal cabin, and a system within the lavatory, as described herein.

### BRIEF DESCRIPTION OF THE DRAWINGS

FIG. 1 illustrates a perspective front view of an aircraft, according to an example of the present disclosure.

FIG. 2 illustrates a perspective internal view of a lavatory, according to an example of the present disclosure.

FIG. 3 illustrates a block diagram of a trash compaction system within an internal cabin of an aircraft, according to an example of the present disclosure.

FIG. 4 illustrates a simplified schematic diagram of a trash compaction system, according to an example of the present disclosure.

FIG. 5 illustrates a simplified schematic diagram of a trash compaction system, according to an example of the present disclosure.

FIG. 6 illustrates a simplified schematic diagram of a trash compacting system, according to an example of the present disclosure.

FIG. 7 illustrates a flow chart of a method, according to an example of the present disclosure.

### DETAILED DESCRIPTION OF THE DISCLOSURE

The foregoing summary, as well as the following detailed description of certain embodiments will be better understood when read in conjunction with the appended drawings. As used herein, an element or step recited in the singular and preceded by the word “a” or “an” should be understood as not necessarily excluding the plural of the elements or steps. Further, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular condition can include additional elements not having that condition.

Examples of the present disclosure provide systems and methods for compacting trash within a trash container. In at least one example, the trash container is within a lavatory of an internal cabin of a vehicle, such as a commercial aircraft. The lavatory includes a sink having a drain, a reservoir in fluid communication with the drain, a water outlet, such as a spray nozzle, in fluid communication the reservoir, and the trash container, which can include a flap. Actuation of the flap is configured to operate the spray nozzle to spray water from the reservoir into a retaining chamber of the trash container to soak, saturate, and compact trash therein. The trash is paper-based, such as facial tissues, paper towels, and the like, which can be saturated and compacted by water. Trash in the form of used paper towels and facial tissues easily absorbs liquids and is easily compressed. However, when uncompressed, such trash consumes significant volume and quickly fills trash containers.

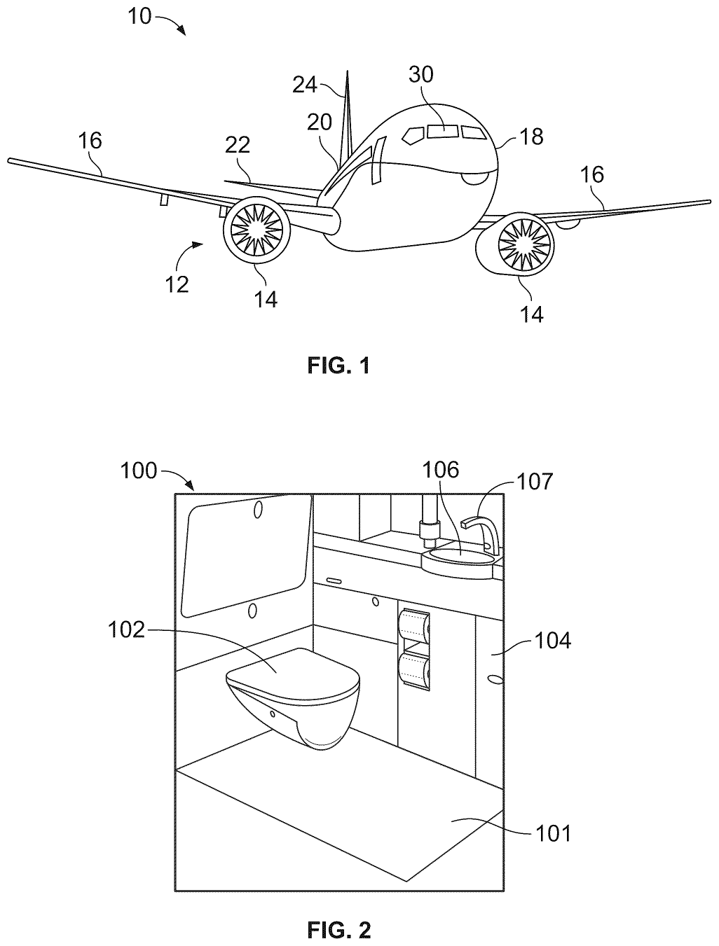

FIG. 1 illustrates a perspective front view of an aircraft 10, according to an example of the present disclosure. The aircraft 10 includes a propulsion system 12 that includes engines 14, for example. Optionally, the propulsion system 12 may include more engines 14 than shown. The engines 14 are carried by wings 16 of the aircraft 10. In other examples, the engines 14 may be carried by a fuselage 18 and/or an empennage 20. The empennage 20 may also support horizontal stabilizers 22 and a vertical stabilizer 24.

The fuselage 18 of the aircraft 10 defines an internal cabin 30, which includes a flight deck or cockpit, one or more work sections (for example, galleys, personnel carry-on baggage areas, and the like), one or more passenger sections (for example, first class, business class, and coach sections), one or more lavatories, and/or the like. Optionally, instead of an aircraft, examples of the present disclosure may be used with various other vehicles, such as automobiles, buses, locomotives and train cars, watercraft, and the like. Further, examples of the present disclosure may be used with respect to fixed structures, such as commercial and residential buildings.

FIG. 2 illustrates a perspective internal view of a lavatory 100, according to an example of the present disclosure. The lavatory 100 may be onboard an aircraft, as described above. Optionally, the lavatory 100 may be onboard various other vehicles. In other examples, the lavatory 100 may be within a fixed structure, such as a commercial or residential building. The lavatory 100 includes a base floor 101 that supports a toilet 102, cabinets 104, and a sink 106 or wash basin. A faucet 107 is configured to flow water into the sink 106. The faucet 107 is in fluid communication with a water supply, such as through one or more conduits, pipes, tubes, and/or the like. The lavatory 100 may be arranged differently than shown. The lavatory 100 may include more or less components than shown.

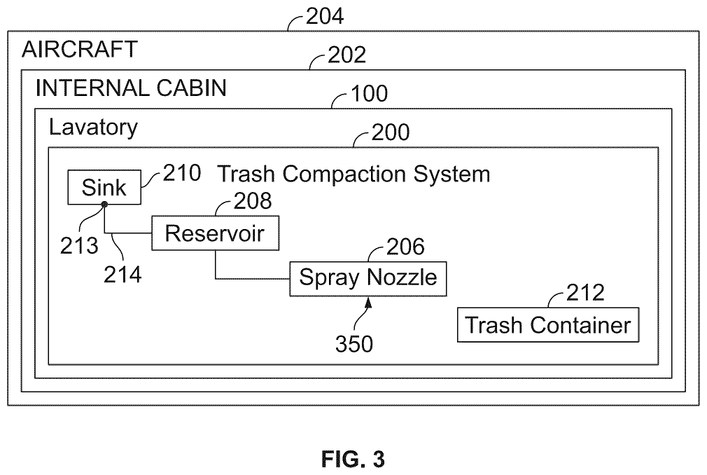

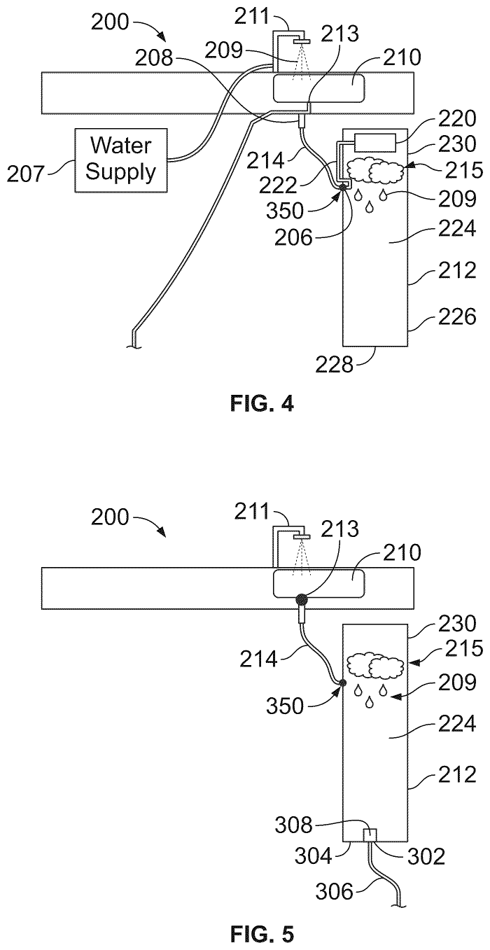

FIG. 3 illustrates a block diagram of a trash compaction system 200 within an internal cabin 202 of an aircraft 204, according to an example of the present disclosure. FIG. 4 illustrates a simplified schematic diagram of the trash compaction system 200, according to an example of the present disclosure. Referring to FIGS. 3 and 4, the trash compaction system 200 includes a water outlet 350, such as a spray nozzle 206, in fluid communication with a reservoir 208, which is configured to receive and retain water. A water supply 207 provides water to a faucet 211, which is configured to be operated to provide water into a sink 210. The water 209 passes through a drain 213 of the sink 210 into a conduit 214 that is in fluid communication with the reservoir 208. In at least one example, the reservoir 208 can be in direct fluid communication with the water supply 207, and also receive water directly from the water supply 207 (in addition to, or instead of, receiving water that is drained from the sink 210).

The water outlet 350 can be the spray nozzle 206, or multiple spray nozzles 206. As another example, the water outlet 350 can be an open end of a conduit (such as an open end of a tube, pipe, or the like). As another example, the water outlet 350 can be a manifold having numerous outlet ports.

Optionally, the trash compacting system 200 may not include the reservoir 208. Instead, the conduit 214 may directly couple the spray nozzle 206 to the drain 213 of the sink 210.

When a cover 220 of a trash container 212 is opened, the spray nozzle 206 is actuated to spray water 209 into the trash container 212 to compact trash 215 within the trash container 212. The cover 220 can be a moveable flap, lid, cap, and/or the like. For example, the spray nozzle 206 and/or the reservoir 208 can include or otherwise be operatively coupled to a valve, which is, in turn, operatively coupled to the cover 220 of the trash container 212 through a linkage 222. The linkage 222 includes one or more actuating arms, beams, pivot axles, and/or the like. Optionally, instead of a mechanical linkage, the system may be electronically operated. For example, the waste flap can be opened via an electric motor (foot pedal, motion, infrared sensor activated, or the like), which, in turn, sends a signal to the spay water onto deposited trash via an electronic pump dispensing system.

When the cover 220 is moved into an open position (such as by being pushed, grasped and lifted upward, moved through a foot pedal coupled thereto, and/or the like), the linkage 222 moves in response, which causes the spray nozzle 206 to emit the water 209 therefrom. For example, the linkage 222 can cause a valve within or otherwise coupled to the spray nozzle 206 to move into an open position, such that the water 209 passes out of the spray nozzle 206. In contrast, when the cover 220 is moved into a closed position, the linkage 222 moves in response, which causes the spray nozzle 206 to close (such as via the valve) to stop the passage of water through the spray nozzle 206.

Crumpled paper towels can be deposited into the trash container 212. The crumpled paper towels can be partially dry, and occupy space within the trash container 212. Stacked, mostly dry crumpled paper towels typically do not have sufficient mass to self-compact. As such, to increase the mass of the paper towels to provide self-compaction, and to reduce occupied space, water generated by sink drainage is used to spray water (for example, 0.5-2.0 oz) into the trash container 212, soaking and saturating the trash contents each time a waste flap of the trash container 212 is cycled.

Lavatories within aircraft typically have sink drain lines that run directly to a drain mast. The water is generally used once before being discarded from the aircraft. In contrast, examples of the present disclosure provide the trash compaction system 200 having the reservoir 208 in fluid communication with the drain 213 of the sink 210. The reservoir 208 is configured to receive a volume of compacting water, such as between 0.5-2.0 oz. In at least one example, the reservoir 208 is fluidly coupled to a nozzle located inside the compartment (such as within a cabinet) that retains the trash container 212. Each actuation of the waste flap sprays water into a retaining chamber of the trash container 212, thereby, soaking, saturating, and compacting trash therein. Further, water that is sprayed from the spray nozzle 206 reduces a potential of waste within the trash container 212 from igniting. Additionally, the use of such water-based compacting eliminates, minimizes, or otherwise reduces a need for a fire extinguisher within the lavatory, thereby (1) reducing overall cost and weight, (2) simplifying maintenance (reduced need to inspect an extinguisher), and (3) simplifying manufacture (less items to be installed). Grey water can be used to soak, saturate, and compact trash contents, as well as aid in fire suppression, fire containment, and fire extinguishing (by saturating waste contents), thereby substantially lowering or preventing a risk of waste content ignition.

FIG. 5 illustrates a simplified schematic diagram of a trash compaction system 200, according to an example of the present disclosure. In this example, the trash container 212 includes a drain 302 at a bottom 304. The drain 302 is in fluid communication with a conduit 306 connected to a fluid removal drain system, for example. As a further example, a float valve 308 is disposed within the trash container 212, such as proximate to the drain 302. For example, the float valve 308 can be disposed on and/or otherwise over the drain 302.

In this example, water passing through the drain 213 of the sink 210 passes into the trash container 212, as described, thereby compacting the trash 215. The trash compacting system 200 may or may not include a separate reservoir. In this example, the trash container 212 can receive all of the water drained from the sink 210. The water 209 descends by gravity to the bottom 304 of the trash container 212. A sufficient amount of water 209 retained at the bottom 304 causes the float valve 308 to move off the drain 302, thereby allowing the water 209 to pass into and through the drain 302, and out of the trash container 212. In this manner, float valve 308 operates to ensure that the trash container 212 does not become too heavy due to retained water, and/or prevent a potential overflow.

Optionally, the trash container 212 may not include the float valve. Instead, the drain 302 can always be open to allow any retained water 209 to pass therethrough. As another example, instead of a float valve, the trash container 212 can include a manual engageable valve disposed on or within the drain 302. The valve can be operated by an individual. As another example, the trash container 212 can be an automatically operated valve.

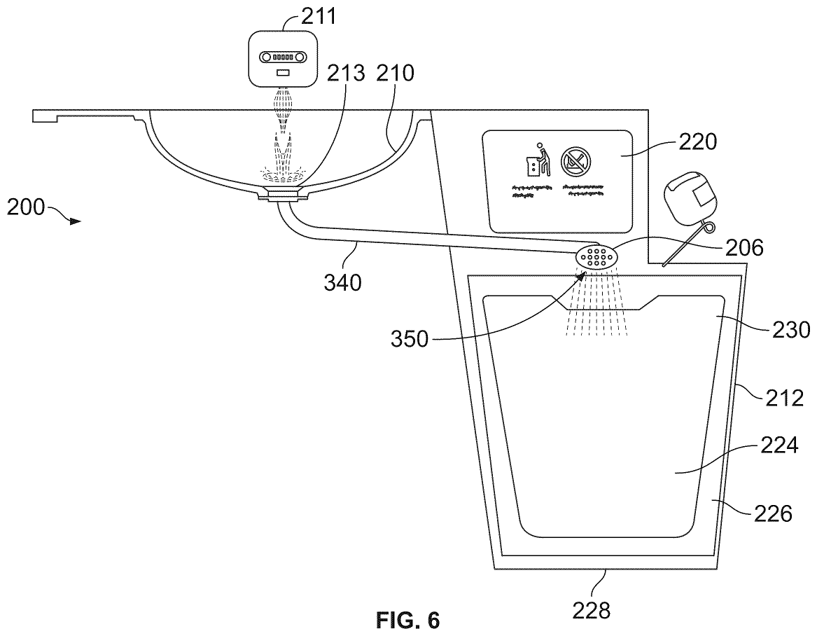

FIG. 6 illustrates a simplified schematic diagram of a trash compacting system 200, according to an example of the present disclosure. In this example, a conduit 340 (such as one or more tubes, one or more pipes, and/or the like) directly couples to the drain 213 of the sink 210 and the spray nozzle 206. In this example, the spray nozzle 206 may not be operatively coupled to the cover 220 of the trash container 212. Further, the trash compacting system 200 may not include a reservoir. Instead, water that flows through the drain 213 of the sink 210 flows directly into the conduit 340, into and out of the spray nozzle 206, and into the trash container 212, as described herein. The trash container 212 can include a drain, as shown and described in FIG. 5.

Referring to FIGS. 3-6, trash (for example, paper towels, facial tissues, etc.) deposited into the trash container 212 is soaked, layer-by-layer within the trash container 212. For example, gray drain water is sprayed on paper towels/facial tissues deposited by one user, by a next user, and so on, thereby absorbing and compacting the contents as each layer of water is deposited.

As described herein, examples of the present disclosure provide a trash compacting system 200 including a trash container 212 configured to retain trash within an internal chamber 224. The internal chamber 224 is defined by one or more walls 226 and a base 228 of the trash container 212. A sink 210 is configured to retain water. The sink 210 includes a drain 213 (such as a first drain) configured to allow the water to pass out of the sink 210. A water outlet 350, such as one or more spray nozzles 206, is disposed proximate to a top 230 of the internal chamber 224 of the trash container 212. For example, the water outlet 350 may extend into and through a wall 226 of the trash container 212, and into and over trash within the internal chamber 224. As another example, the water outlet 350 may extend over an open top of the trash container 212. As another example, the water outlet 350 may be supported over a top edge of a wall 226 of the trash container 212. One or more conduits 214 or 340 fluidly connect the drain 213 to the water outlet 350. The water outlet 350 is configured to receive the water that passes out of the sink 210 via the one or more conduits 214 or 340. The water soaks, saturates, and compacts the trash 215 within the internal chamber 224.

In at least one example, a reservoir 208 fluidly connects the water outlet 350 and the one or more conduits, 214 or 340. The reservoir 208 is configured to receive the water that passes out of the sink 210.

In at least one example, the trash container 212 includes a cover 220 configured to be moved between an open position and a closed position. A linkage 222 operatively couples the cover 220 to one or both of the water outlet 350 or the reservoir 208. Movement of the cover 220 into the open position is configured to allow the water to pass out of the water outlet 350. Optionally, an electronic system can be used in place of a mechanical linkage.

In at least one example, the trash container 212 includes a drain 302 (for example, a second drain). Water retained within the trash container 212 passes out of the drain 302. In at least one example, the trash container 212 also includes a valve (such as a float valve 308) proximate to the drain 302.

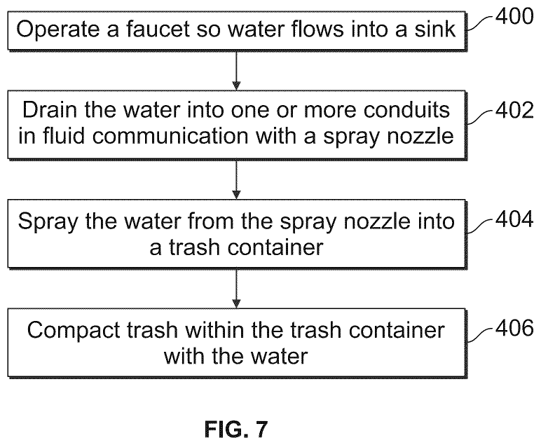

FIG. 7 illustrates a flow chart of a method, according to an example of the present disclosure. At 400, a faucet is operated (such as by manually grasping and turning a valve into an open position) so that water flows into a sink. At 402, the water in the sink is drained into one or more conduits in fluid communication with a water outlet, such as one or more spray nozzles. At 404, the water is sprayed or otherwise passes out of the spray nozzle into a trash container. At 406, trash within the trash container is soaked, saturated, and compacted with the water. Saturation of the trash causes compaction of the trash.

Further, the disclosure comprises examples according to the following clauses:
Clause 1. A system comprising:
a trash container configured to retain trash within an internal chamber;
a sink configured to retain water, wherein the sink comprises a first drain configured to allow the water to pass out of the sink;
a water outlet disposed proximate to a top of the internal chamber of the trash container; and
one or more conduits that fluidly connect the first drain to the water outlet,
wherein the water outlet is configured to receive the water that passes out of the sink via the one or more conduits, and wherein the water compacts the trash within the internal chamber.
Clause 2. The system of Clause 1, further comprising a reservoir fluidly connecting the water outlet and the one or more conduits, wherein the reservoir is configured to receive a portion of the water that passes out of the sink.
Clause 3. The system of Clause 2, wherein the trash container comprises a cover configured to be moved between an open position and a closed position, wherein a linkage operatively couples the cover to one or both of the water outlet or the reservoir, and wherein movement of the cover into the open position is configured to allow the water to pass out of the water outlet. The linkage can be mechanical and/or an electronic coupling.
Clause 4. The system of any of Clauses 1-3, wherein the trash container comprises a second drain, and wherein the second drain is configured to allow the water to pass therethrough.
Clause 5. The system of Clause 4, wherein the trash container further comprises a valve proximate to the second drain.
Clause 6. The system of Clause 5, wherein the valve is a float valve.
Clause 7. The system of any of Clauses 1-6, wherein the water outlet comprises one or more spray nozzles.
Clause 8. A method for a system comprising:
a trash container configured to retain trash within an internal chamber;
a sink configured to retain water, wherein the sink comprises a first drain configured to allow the water to pass out of the sink;
a water outlet disposed proximate to a top of the internal chamber of the trash container; and
one or more conduits that fluidly connect the first drain to the water outlet,
wherein the water outlet is configured to receive the water that passes out of the sink via the one or more conduits, and wherein the water compacts the trash within the internal chamber,
the method comprising:
soaking, saturating, and compacting the trash within the internal chamber of the trash container with water that passes out of the water outlet.
Clause 9. The method of Clause 8, further comprising receiving, by a reservoir fluidly connecting the water outlet and the one or more conduits, the water that passes out of the sink.
Clause 10. The method of Clause 9, further comprising:
moving a cover of the trash container into an open position; and
allowing the water to pass out of the water outlet in response to said moving.
Clause 11. The method of any of Clauses 8-10, further comprising allowing the water to pass through a second drain of the trash container.
Clause 12. The method of Clause 11, wherein the trash container further comprises a valve proximate to the second drain.
Clause 13. The method of Clause 12, wherein the valve is a float valve.
Clause 14. The method of any of Clauses 8-13, wherein the water outlet comprises one or more spray nozzles.
Clause 15. A vehicle comprising:
an internal cabin;
a lavatory within the internal cabin; and
a system within the lavatory, the comprising:
   a trash container configured to retain trash within an internal chamber;
   a sink configured to retain water, wherein the sink comprises a first drain configured to allow the water to pass out of the sink;
   a water outlet disposed proximate to a top of the internal chamber of the trash container; and
   one or more conduits that fluidly connect the first drain to the water outlet,
   wherein the water outlet is configured to receive the water that passes out of the sink via the one or more conduits, and wherein the water soaks, saturates, and compacts the trash within the internal chamber.
Clause 16. The vehicle of Clause 15, wherein the vehicle is an aircraft.
Clause 17. The vehicle of Clauses 15 or 16, wherein the system further comprises a reservoir fluidly connecting the water outlet and the one or more conduits, wherein the reservoir is configured to receive a portion of the water that passes out of the sink.
Clause 18. The vehicle of Clause 17, wherein the trash container comprises a cover configured to be moved between an open position and a closed position, wherein a linkage operatively couples the cover to one or both of the water outlet or the reservoir, and wherein movement of the cover into the open position is configured to allow the water to pass out of the water outlet. The linkage can be a mechanical and/or an electronic coupling.
Clause 19. The vehicle of Clause 18, wherein the trash container comprises a second drain, and wherein the second drain is configured to allow the water to pass therethrough.
Clause 20. The vehicle of Clause 19, wherein the trash container further comprises a valve proximate to the second drain.

As described herein, examples of the present disclosure provide systems and methods for effectively and efficiently compacting trash within a trash receptable, such as within a lavatory of a commercial aircraft.

While various spatial and directional terms, such as top, bottom, lower, mid, lateral, horizontal, vertical, front and the like can be used to describe embodiments of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described embodiments (and/or aspects thereof) can be used in combination with each other. In addition, many modifications can be made to adapt a particular situation or material to the teachings of the various embodiments of the disclosure without departing from their scope. While the dimensions and types of materials described herein are intended to define the parameters of the various embodiments of the disclosure, the embodiments are by no means limiting and are exemplary embodiments. Many other embodiments will be apparent to those of skill in the art upon reviewing the above description. The scope of the various embodiments of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112 (f), unless and until such claim limitations expressly use the phrase “means for” followed by a statement of function void of further structure.

This written description uses examples to disclose the various embodiments of the disclosure, including the best mode, and also to enable any person skilled in the art to practice the various embodiments of the disclosure, including making and using any devices or systems and performing any incorporated methods. The patentable scope of the various embodiments of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A system comprising:
a trash container configured to retain trash within an internal chamber;
a sink configured to retain water, wherein the sink comprises a first drain configured to allow the water to pass out of the sink;
a water outlet disposed proximate to a top of the internal chamber of the trash container; and
one or more conduits that fluidly connect the first drain to the water outlet,
wherein the water outlet is configured to receive the water that passes out of the sink via the one or more conduits such that the water saturates and compacts the trash within the internal chamber.

2. The system of claim 1, further comprising a reservoir fluidly connecting the water outlet and the one or more conduits, wherein the reservoir is configured to receive a portion of the water that passes out of the sink.

3. The system of claim 2, wherein the trash container comprises a cover configured to be moved between an open position and a closed position, wherein a linkage operatively couples the cover to one or both of the water outlet or the reservoir, and wherein movement of the cover into the open position is configured to allow the water to pass out of the water outlet.

4. The system of claim 1, wherein the trash container comprises a second drain, and wherein the second drain is configured to allow the water to pass therethrough.

5. The system of claim 4, wherein the trash container further comprises a valve proximate to the second drain.

6. The system of claim 5, wherein the valve is a float valve.

7. The system of claim 1, wherein the water outlet comprises one or more spray nozzles.

8. A method for a system comprising:
a trash container configured to retain trash within an internal chamber;
a sink configured to retain water, wherein the sink comprises a first drain configured to allow the water to pass out of the sink;
a water outlet disposed proximate to a top of the internal chamber of the trash container; and
one or more conduits that fluidly connect the first drain to the water outlet,
wherein the water outlet is configured to receive the water that passes out of the sink via the one or more conduits such that the water compacts the trash within the internal chamber,
the method comprising:
saturating and compacting the trash within the internal chamber of the trash container with water that passes out of the water outlet.

9. The method of claim 8, further comprising receiving, by a reservoir fluidly connecting the water outlet and the one or more conduits, the water that passes out of the sink.

10. The method of claim 9, further comprising:
moving a cover of the trash container into an open position; and
allowing the water to pass out of the water outlet in response to said moving.

11. The method of claim 8, further comprising allowing the water to pass through a second drain of the trash container.

12. The method of claim 11, wherein the trash container further comprises a valve proximate to the second drain.

13. The method of claim 12, wherein the valve is a float valve.

14. The method of claim 8, wherein the water outlet comprises one or more spray nozzles.

15. A vehicle comprising:
an internal cabin;
a lavatory within the internal cabin; and
a system within the lavatory, the system comprising:
a trash container configured to retain trash within an internal chamber;
a sink configured to retain water, wherein the sink comprises a first drain configured to allow the water to pass out of the sink;
a water outlet disposed proximate to a top of the internal chamber of the trash container; and
one or more conduits that fluidly connect the first drain to the water outlet,
wherein the water outlet is configured to receive the water that passes out of the sink via the one or more conduits such that the water saturates and compacts the trash within the internal chamber.

16. The vehicle of claim 15, wherein the vehicle is an aircraft.

17. The vehicle of claim 15, wherein the system further comprises a reservoir fluidly connecting the water outlet and the one or more conduits, wherein the reservoir is configured to receive a portion of the water that passes out of the sink.

18. The vehicle of claim 17, wherein the trash container comprises a cover configured to be moved between an open position and a closed position, wherein a linkage operatively couples the cover to one or both of the water outlet or the reservoir, and wherein movement of the cover into the open position is configured to allow the water to pass out of the water outlet.

19. The vehicle of claim 18, wherein the trash container comprises a second drain, and wherein the second drain is configured to allow the water to pass therethrough.

20. The vehicle of claim 19, wherein the trash container further comprises a valve proximate to the second drain.
